(19) United States
(12) Patent Application Publication
(10) Pub. No.: US 2019/0324528 A1
(43) Pub. Date: Oct. 24, 2019

(54) ADJUSTING GAZE POINT BASED ON DETERMINED OFFSET ADJUSTMENT

(71) Applicant: Microsoft Technology Licensing, LLC, Redmond, WA (US)

(72) Inventors: Shane Frandon WILLIAMS, Seattle, WA (US); James TICHENOR, Seattle, WA (US); Sophie STELLMACH, Seattle, WA (US); Andrew David WILSON, Seattle, WA (US)

(21) Appl. No.: 15/958,605

(22) Filed: Apr. 20, 2018

(51) Int. Cl. G06F 3/01; G06K 9/00; G06K 9/62

(52) U.S. Cl. CPC G06F 3/013; G06K 9/00604; G06K 9/0061; G06K 9/6253; G06K 9/00375

(57) ABSTRACT

A head mounted display device provides offset adjustments for gaze points provided by an eye tracking component. In a model generation phase, heuristics are used to estimate a gaze point of the user based on the gaze point provided by the eye tracking component and features that are visible in the field of view of the user. The features may include objects, edges, faces, and text. If the estimated gaze point is different than the gaze point that was provided by the eye tracking component, the difference is used to train a model along with a confidence value that reflects the strength of the estimated gaze point. In an adjustment phase, when the user is using an application that relies on the eye tracking component, the generated model is used to determine offsets to adjust the gaze points that are provided by the eye tracking component.

### BACKGROUND

Optical eye tracking components are used to determine a gaze point for a user. Eye tracking can be used as a form of user input and may be useful for virtual reality (“VR”) and augmented reality (“AR”) applications.

While useful, current eye tracking components require a complicated calibration process to operate properly. Usually the calibration process asks the user to focus on a variety of points with known locations on a display. As the user focuses on each point, properties about the user's eye physiology and angle kappa are captured with respect to the point. The captured data is used to calibrate the eye tracking component for the user.

Current eye tracking components are very sensitive to changes in pupil size (due to different user stress levels) and lighting condition. Accordingly, a calibration that worked well for a user one day may not be adequate for the same user the next day. Given the time-consuming nature of recalibrating the eye tracking components, there is a need to correct for calibration errors without having to recalibrate the eye tracking components every time there is a change to a lighting condition or pupil size for a user.

### SUMMARY

A head mounted display device provides offset adjustments for gaze points provided by an eye tracking component. In a model generation phase, as a user wears the head mounted display device, heuristics are used to estimate a gaze point of the user based on the gaze point provided by the eye tracking component and features that are visible in the field of view of the user. These features may include objects, edges, faces, and text. If the estimated gaze point is different than the gaze point that was provided by the eye tracking component, the difference between the gaze points and a confidence value that reflects the strength of the estimated gaze point is used to train a model. In an adjustment phase, when the user is later using an application that relies on the eye tracking component, the generated model may be used to determine offsets that can be used to adjust the gaze points that are provided by the eye tracking component.

In an implementation, a system for determining estimated gaze points based on received gaze points to avoid recalibration of an eye tracking component is provided. The system includes a head mounted display device and an adjustment engine. The adjustment engine: detects a plurality of features in a field of view of the head mounted display device, wherein each feature is associated with coordinates on the head mounted display device; receives a first gaze point, wherein the first gaze point is associated with coordinates on the head mounted display device; based on the coordinates associated with the first gaze point and the coordinates associated with at least one feature of the plurality of features, determines an estimated gaze point; and provides the determined estimated gaze point to an adjustment model.

In an implementation, a system for adjusting gaze points without recalibrating an eye tracking component is provided. The system includes a head mounted display device, an eye tracking component, and an adjustment engine. The adjustment engine: generates an adjustment model for a wearer of the head mounted display device; receives a first gaze point for the user from the eye tracking component, wherein the first gaze point is associated with coordinates on the head mounted display device; based on the adjustment model and the coordinates associated with the first gaze point, determines an offset adjustment for the first gaze point; adjusts the first gaze point based on the determined offset adjustment; and provides the adjusted first gaze point to an application.

In an implementation, a method for determining estimated gaze points based on received gaze points to reduce recalibration of an eye tracking component is provided. The method includes: detecting a plurality of features in a field of view of a head mounted display device, wherein each feature is associated with coordinates on the head mounted display device; receiving a gaze point by the head mounted display device, wherein the gaze point is associated with coordinates on the head mounted display device; based on the coordinates associated with the received gaze point and the coordinates associated with at least one feature of the plurality of features, determining an estimated gaze point by the head mounted display device; calculating a confidence value for the determined estimated gaze point by the head mounted display device; and providing the determined estimated gaze point and determined confidence value to an adjustment model by the head mounted display device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example head mounted display device;

FIG. 2 is an illustration of an exemplary environment for generating offset adjustments;

FIG. 3 is an illustration of an implementation of an exemplary adjustment engine;

FIGS. 4-7 are illustrations of an example environment showing how estimated gaze points may be generated based on received gaze points;

FIG. 8 is an operational flow of an implementation of a method for determining an estimated gaze point based on a gaze point received from an eye tracking component;

FIG. 9 is an operational flow of an implementation of a method for generating an adjustment model and for adjusting a received gaze point using the generated adjustment model;

FIG. 10 is an operational flow of an implementation of a method for determining an estimated gaze point and a confidence value based on a gaze point received from an eye tracking component; and

FIG. 11 shows an exemplary computing environment in which example embodiments and aspects may be implemented.

### DETAILED DESCRIPTION

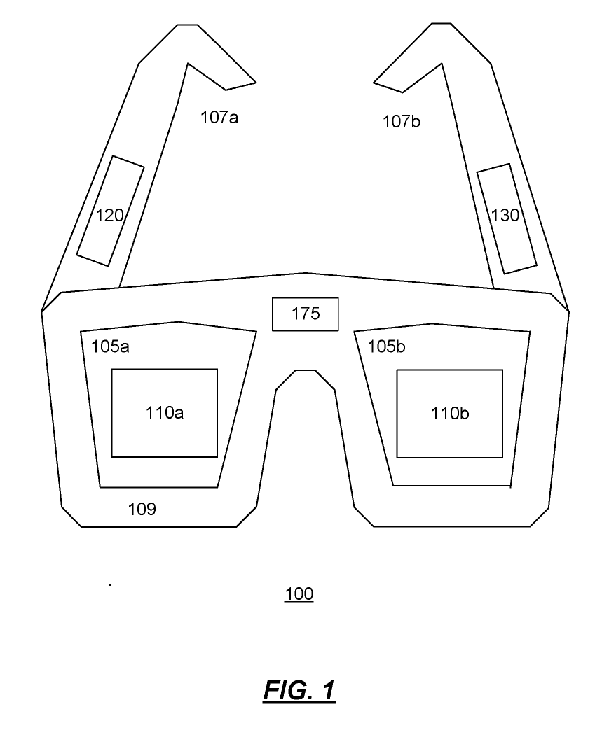

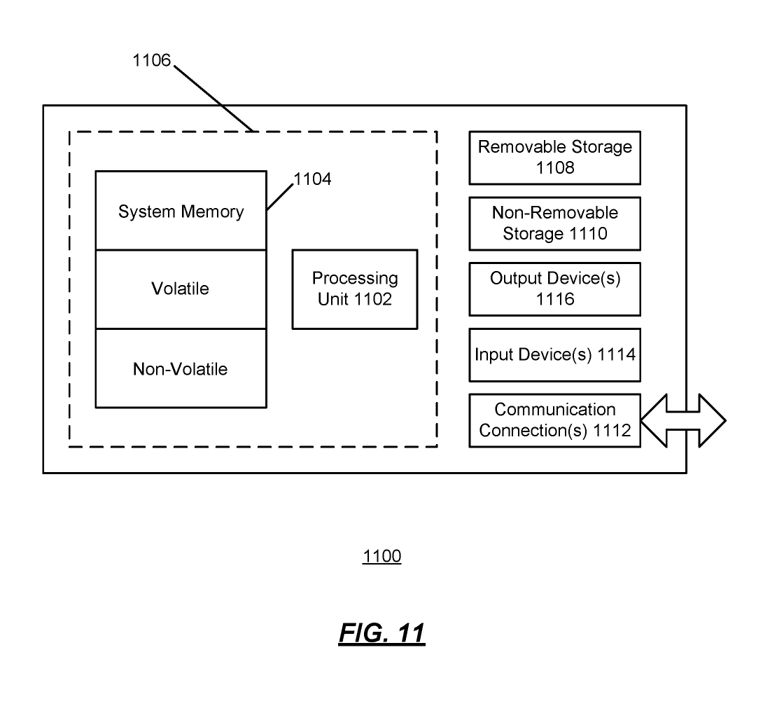

FIG. 1 is an illustration of an example head mounted display (“HMD”) device 100, In an implementation, the HMD device 100 is a pair of glasses. The HMD device 100 includes lenses 105a and 105b arranged within a frame 109. The frame 109 is connected to a pair of temples 107a and 107b. Arranged between each of the lenses 105 and a wearer or user's eyes is a near eye display system 110. The system 110a is arranged in front of a right eye and behind the lens 105a. The system 110b is arranged in front of a left eye and behind the lens 105b. The HMD device 100 also includes a controller 120 and one or more sensors 130. The controller 120 may be a computing device operatively coupled to both near eye display systems 110a and 110b and to the sensors 130. A suitable computing device is illustrated in FIG. 11 as the computing device 1100.

The sensors 130 may be arranged in any suitable location on the HMD device 100. They may include a gyroscope or other inertial sensors, a global-positioning system (GPS) receiver, and/or a barometric pressure sensor configured for altimetry. The sensors 130 may provide data on the wearer's location or orientation. From the integrated responses of the sensors 130, the controller 120 may track the movement of the HMD device 100 within the wearer's environment.

In some implementations, the HMD device 100 may include an eye tracking component 175 that is configured to detect an ocular state of the wearer of the HMD device 100. The eye tracking component 175 may locate a line of sight of the wearer, measure an extent of iris closure, etc. The eye tracking component 175 may further generate one or more gaze points. The gaze point may represent the location that the user is looking at with respect to the near eye display systems 110a and 110b. This information may be used by the controller 120 for placement of a computer-generated image frame, or as input to one or more applications executed by the controller 120. The image frame may be a frame of a video, or the output of a computer application such as a video game, for example.

In some implementations, each of the near eye display systems 110a and 110b may be at least partly transparent, to provide a substantially unobstructed field of view in which the wearer can directly observe their physical surroundings. Each of the near eye display systems 110a and 110b may be configured to present, in the same field of view, a computer-generated image frame.

The controller 120 may control the internal componentry of the near eye display systems 110a and 110b to form the desired image frame. In an implementation, the controller 120 may cause the near eye display systems 110a and 110b to display approximately the same image frame concurrently, so that the wearer's right and left eyes receive the same image frame at approximately the same time. In other implementations, the near eye display systems 110a and 110b may project somewhat different image frames concurrently, so that the wearer perceives a stereoscopic, i.e., three-dimensional, image frame.

In some implementations, the computer-generated image frames and various real images of objects sighted through the near eye display systems 110a and 110b may occupy different focal planes. Accordingly, the wearer observing a real-world object may shift their corneal focus to resolve the image frame. In other implementations, the image frame and at least one real image may share a common focal plane.

In the HMD device 100, each of the near eye display systems 110a and 110b may also be configured to acquire video of the surroundings sighted by the wearer. The video may include depth video and may be used to establish the wearer's location, what the wearer sees, etc. The video acquired by each near eye display system 110a, 110b may be received by the controller 120, and the controller 120 may be configured to process the video received. To this end, the HMD device 100 may include a camera. The optical axis of the camera may be aligned parallel to a line of sight of the wearer of the HMD device 100, such that the camera acquires video of the external imagery sighted by the wearer. As the HMD device 100 may include two near eye display systems 110—one for each eye—it may also include two cameras. More generally, the nature and number of the cameras may differ in the various embodiments of this disclosure. One or more cameras may be configured to provide video from which a time-resolved sequence of three-dimensional depth maps is obtained via downstream processing.

No aspect of FIG. 1 is intended to be limiting in any sense, for numerous variants are contemplated as well. In some embodiments, for example, a vision system separate from the HMD device 100 may be used to acquire video of what the wearer sees. In some embodiments, a single near eye display system 110 extending over both eyes may be used instead of the dual monocular near eye display systems 110a and 110b shown in FIG. 1.

The HMD device 100 may be used to support a virtual-reality (“VR”) or augmented-reality (“AR”) environment for one or more participants. A realistic AR experience may be achieved with each AR participant viewing their environment naturally, through passive optics of the HMD device 100. Computer generated imagery may be projected into the same field of view in which the real-world imagery is received. Imagery from both sources may appear to share the same physical space.

The controller 120 in the HMD device 100 may be configured to run one or more applications that support the VR or AR environment. In some implementations, one or more applications may run on the controller 120 of the HMD device 100, and others may run on an external computer accessible to the HMD device 100 via one or more wired or wireless communication links. Accordingly, the HMD device 100 may include suitable wireless componentry, such as Wi-Fi.

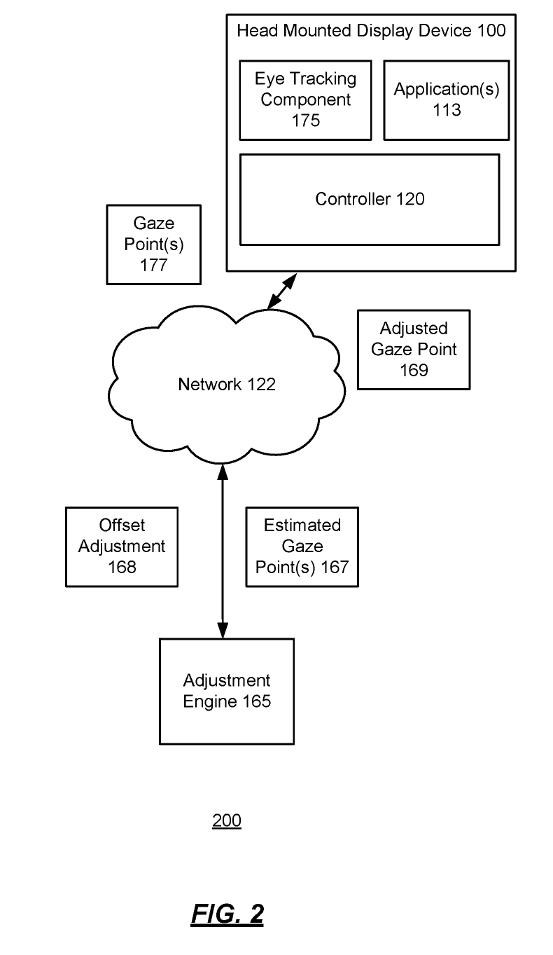

FIG. 2 is an illustration of an exemplary environment for generating offset adjustments. The environment 200 may include an HMD device 100 and an adjustment engine 165 in communication through a network 122. The network 122 may be a variety of network types including the public switched telephone network (PSTN), a cellular telephone network, and a packet switched network (e.g., the Internet). Although only one HMD device 100 and one adjustment engine 165 are shown in FIG. 2, there is no limit to the number of HMD devices 100 and adjustment engines 165 that may be supported.

The HMD device 100 and the adjustment engine 165 may be implemented using a variety of computing devices such as smartphones, desktop computers, laptop computers, tablets, set top boxes, vehicle navigation systems, and videogame consoles. Other types of computing devices may be supported. A suitable computing device is illustrated in FIG. 11 as the computing device 1100. In addition, while the adjustment engine 165 and HMD device 100 are shown as separate devices, all may be implemented together on one or more computing devices 1100.

The eye tracking component 175 may track the movement and position of the eye or eyes of a wearer or user of the HMD device 100, and based on the tracked movement and position, may generate a gaze point 177. The gaze point 177 may include coordinates relative to the near eye display system 110 of the HMD device 100 that the user is viewing. Depending on the implementation, the coordinates may be two-dimensional coordinates (e.g., x and y coordinates) or three-dimensional coordinates (e.g., x, y, and z coordinates). The coordinates may identify a pixel or pixel region of the near eye display system 110.

The gaze point 177 may be used as input to a variety of applications 113 that may be executed by the controller 120 of the HMD device 100. These applications 113 may include AR and VR applications 113. For example, a VR or AR application may allow a user to select or interact with objects in the environment based on the objects that the user is looking at using the gaze point 177 provided by the eye tracking component 175.

As described above, the eye tracking component 175 may generate the gaze point 177 based on user eye movement and position after going through a calibration process with the user. The calibration process may be arduous and may force the user to consecutively focus on certain known locations using the HMD device 100 while the movement and position of the user's eyes are measured. However, if certain conditions such room lighting and user pupil size later change, the calibration may become invalid and may require a recalibration. However, such a recalibration may be time consuming and inconvenient for the user.

Accordingly, to avoid such recalibration, the environment 200 includes the adjustment engine 165. When the user begins interacting with an application 113 that supports eye tracking, the eye tracking component 175 may generate a gaze point 177 for the user. The adjustment engine 165 may receive the gaze point 177, and may use a user specific adjustment model to determine an offset adjustment 168 for the received gaze point 177. Depending on the implementation, the offset adjustment 168 may be a vector or set of values to add to the coordinates associated with the gaze point 177. The adjustment engine 168 may use the gaze point 177 and the offset adjustment 168 to generate the adjusted gaze point 169, which may be provided as input to the application 113 that supports eye tracking. The adjusted gaze point 169 may correct for the calibration errors associated with the gaze point 177, and therefore avoid recalibration of the eye tracking component 175.

As described further herein, to generate the user specific model that is used to generate the adjusted gaze point 169 from the gaze point 177 provided by the eye tracking component 175, the adjustment engine 165 may enter what is referred to herein as the model generation phase. The HMD device 100 may enter the model generation phase when the user is performing their normal workflow and is not using any applications 113 that rely on the gaze points 177 provided by the eye tracking component 175. For example, during a normal workflow, a user may be wearing the HMD device 100 while the user walks around, or performs tasks such as reading, watching television, using a computer, socializing, etc.

During the model generation phase, the adjustment engine 165 may monitor the features that are visible in the field of view of the user through the near eye display system 110 to try to guess an estimated gaze point 167 for the user. Features as used herein may include any features that are visible in the field of view of the user and may include objects (virtual and real), edges, corners, faces, and text. Other types of features may be supported.

The estimated gaze point 167 may be based on the gaze point 177 received from the eye tracking component 175, and one or more heuristics that are based on what features users typically look at while they interact with their environment. For example, when a user targets a feature such as an object by grabbing it with their hand, the user typically looks at their hand and/or the targeted object immediately prior to grabbing the object. The coordinates of the grabbed object and/or hand with respect to the near eye display system 110 may be used for the estimated gaze point 167. Other heuristics may be used.

The coordinates of the estimated gaze point 167 and the coordinates of the received gaze point 177 can be used to train the user specific model. If the coordinates are the same, then the model may determine that no adjustment is necessary for the coordinates. However, if the coordinates are different, then the model may incorporate the difference for the coordinates associated with the gaze point 177. Over time, the model may be trained based on determined differences for a variety of coordinate locations on the near eye display system 110 associated with the HMD device 100.

When the user later begins to use an application 113 that uses eye tracking (e.g., a VR or an AR application 113), the adjustment engine 165 may enter what is referred to as the adjustment phase. During the adjustment phase, when a gaze point 177 is received for an application 113 the adjustment engine 165 may use the coordinates associated with the gaze point 177 and the model to determine the offset adjustment 168. The offset adjustment 168 can be added to the coordinates of the gaze point 177 to correct the received gaze point 177 based on the information collected during the model generation phase.

The adjustment engine 165 may use the offset adjustment 168 to generate an adjusted gaze point 169. The adjusted gaze point 169 may be provided to the application 113 instead of the gaze point 177 received from the eye tracking component 175.

As may be appreciated, the adjustment engine 165 provides may advantages over current eye tracking components 175. First, the adjustment engine 165 allows for the correction of an incorrectly calibrated eye tracking component 175 without the user having to undertake a complete recalibration. This saves the user from the time and frustration caused by a poorly calibrated eye tracking component 175. Second, because the model building phase can occur seamlessly in the background while the user performs their normal workflow, no additional time or work is required by the user to realize the improved eye tracking experience provided by the adjustment engine 165.

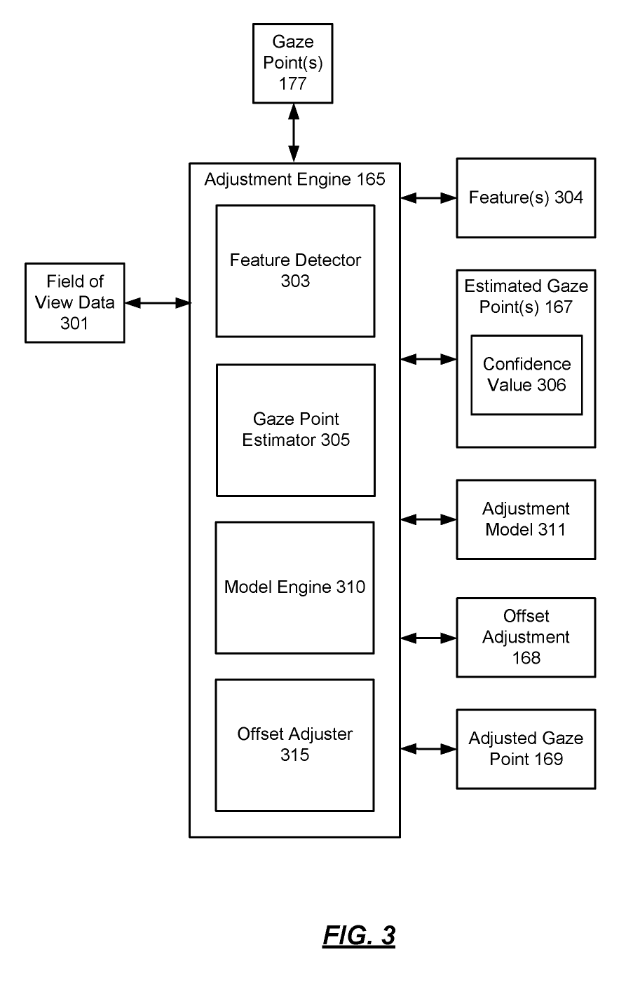

FIG. 3 is an illustration of an implementation of an exemplary adjustment engine 165. The adjustment engine 165 may comprise one or more components including a feature detector 303, a gaze point estimator 305, a model engine 310, and an offset adjuster 315. More or fewer components may be included in the adjustment engine 165. Some or all of the components of the adjustment engine 165 may be implemented by one or more computing devices such as the computing device 1100 described with respect to FIG. 11. In addition, some or all of the functionality attributed to the adjustment engine 165 may be performed by the HMD device 100, or some combination of the HMD device 100 and the adjustment engine 165.

The feature detector 303 may detect one or more features 304 that are visible to a user of the HMD device 100 or that are in a field of view of the HMD device 100. The features 304 may include a variety of features such as objects, edges, corners, text, and faces. Other types of features 304 may be detected.

With respect to object features, the objects may include real objects and virtual objects. A real object is any object that is visible to the user and that exists in the environment of the user. These may include furniture, art, tools, buttons, etc. In addition, these real objects may include objects that are visible to the user on a display such as a television display or a computer display and may include icons or graphical user elements. The virtual objects may include objects that are not real, but are rather generated and displayed by the HMD device 100 to the user. Any method for detecting real and virtual objects may be used.

With respect to edge features, the detected edges may include lines where different surfaces come together. Example edges may include edges of tables, desks, and floors, etc. Edges may be interesting visual features because research has shown that users typically focus on edges when entering a new environment. Any method for detecting edges may be used.

With respect to corner features, the detected corners may be the ends of one or more edges. Example corners may include a table corner, or the corners of the room. Like edges, corners may be interesting visual features because users often focus on corners when in initially scanning their environment. Any method for detecting corners may be used.

With respect to text features, the detected text features may include writing such as words and phrases in the environment of the user. Users typically focus on text features to read the content associated with the features. Any method for detecting text in an environment may be used.

With respect to face features, the detected face features may include faces of humans or animals in the environment of the user. Users typically look at the faces of humans or animals when interacting with them. Any method for detecting faces may be used.

The feature detector 303 may determine one or more features 304 from field of view data 301. The field of view data 301 may include image data and/or video data that represents the environment that the user is currently viewing through the HMD device 100. Depending on the implementation, the field of view data 301 may be generated using a camera associated with the HMD device 100. The field of view data 301 may also include any virtual objects or graphics that are generated and rendered by the HMD device 100.

Each feature 304 determined by the feature detector 303 may include information such as the size of the feature 304 and coordinates of the feature 304. The coordinates of the feature 304 may be relative to the near eye display system 110 of the HMD device 100. The information may further include information specific to the type of the feature 304. For example, a face feature may include information such as the coordinates of the eyes of the face, and a text feature may include information such as the font used and the line spacing associated with the text feature. Other information may be included.

The gaze point estimator 305 may determine estimated gaze points 167 from received gaze points 177 during an adjustment model generation phase. The adjustment model generation phase may operate during a normal workflow associated with the user. For example, the normal workflow may include when the user is wearing the HMD device 100, but may not be using a VR or AR application 113. However, the eye tracking component 175 may still provide gaze points 177 even though no application 113 is making use of such information.

The gaze point estimator 305 may generate an estimated gaze point 167 for a user based on the detected features 304 and a gaze point 177 received from the eye tracking component 175. The gaze point 177 received from the eye tracking component 175 may include coordinates that identify a location on the near eye display systems 110 of the HMD device 100.

The gaze point estimator 305 may generate an estimated gaze point 167 for a user based on the determined features 304 and the received gaze point 177 using one or more heuristics. The heuristics may be assumptions that are based on observations on how users typically look and interact with their environment. One such heuristic is referred to herein as the targeting heuristic. The targeting heuristic assumes that a user looks at a feature 304 such as a button immediately before targeting the button with their hand. When the user targets a feature 304, it may be considered a strong signal that the user's gaze point is at the targeted feature 304.

Accordingly, when the gaze point estimator 305 has determined that the user has targeted a particular feature 304, the gaze point estimator 305 may generate an estimated gaze point 167 that has coordinates that are based on the coordinates associated with the targeted feature 304 and/or the hand that was used to target the feature 304. For example, the estimated gaze point 167 may have the coordinates of a center of the targeted feature 304.

Another heuristic is referred to herein as the salient feature heuristic. The salient feature heuristic assumes that the true gaze point 177 of the user is likely to be one or more salient features that are the closest to the received gaze point 177 in the field of view of the user. A salient feature may be an object or other feature 304 that has a high contrast edge with respect to the environment of the user and may include objects such as tables, chairs, etc. The salient features may also include elements of a graphical user interface being viewed by a user. These may include images, buttons, sliders, etc.

Accordingly, when the gaze point 177 received from the eye tracking component 175 has coordinates that are near one or more salient features from the field of view, the gaze point estimator 305 may assume that the user is looking at the salient feature that is the closest to the received gaze point 177. The gaze point estimator 305 may generate an estimated gaze point 167 with coordinates that are based on the coordinates of the closest salient feature. For example, the estimated gaze point 167 may have the coordinates of a center of the closest salient feature. Depending on the implementation, the closest salient feature may be within a threshold distance of the gaze point 177 received from the eye tracking component 175 with respect to the near eye display system 110.

Another heuristic is referred to herein as the text heuristic. Like the salient feature heuristic, the text heuristic assumes that when the features 304 include text features that the true eye gaze point 177 of the user is likely to be one of the text features that are close to the received gaze point 177. Text features may include words, phrases, and sentences, for example. Text features may appear on signs or posters in the field of view of the user, or in a graphical user interface in the field of view of the user, for example.

Accordingly, when the gaze point 177 received from the eye tracking component 175 has coordinates that are near text features, the gaze point estimator 305 may assume that the user is looking at the text feature that is the closest to the received gaze point 177. The gaze point estimator 305 may generate an estimated gaze point 167 with coordinates that are based on the coordinates of the closest text feature. For example, the estimated gaze point 167 may have the coordinates of a center of the closest text feature. Depending on the implementation, the closest text feature may be within a threshold distance of the gaze point 177 received from the eye tracking component 175 with respect to the near eye display system 110.

Another heuristic is referred to herein as the face heuristic. The face heuristic assumes that when the features 304 include face features that the true eye gaze point 177 of the user is likely to be one of the face features that are close to the received gaze point 177. The face features may include human faces and animal faces. Depending on the implementation, the face features may further identify facial components such as eyes or mouths.

Accordingly, when the gaze point 177 received from the eye tracking component 175 has coordinates that are near one or more face features, the gaze point estimator 305 may assume that the user is looking at the face feature that is the closest to the received gaze point 177. The gaze point estimator 305 may generate an estimated gaze point 167 with coordinates that are based on the coordinates of the closest face feature. For example, the estimated gaze point 167 may have the coordinates of a center of the closest face feature 304, or the coordinates of the eyes or mouth of the closest face feature 304.

Another heuristic is referred to herein as the edge heuristic. The edge heuristic assumes that when a user enters a new environment such as a room, the user initially scans the environment by looking at the various edges or corners of the room. Thus, the true eye gaze point 177 of the user is likely to be one of the edge features that are close to the received gaze point 177.

Accordingly, when the gaze point 177 received from the eye tracking component 175 has coordinates that are near one or more edge features, the gaze point estimator 305 may assume that the user is looking at the edge feature that is the closest to the received gaze point 177. The gaze point estimator 305 may generate an estimated gaze point 167 with coordinates that are based on the coordinates of the closest edge feature. For example, the estimated gaze point 167 may have coordinates that are determined by shifting the coordinates of the received gaze point 177 based on the coordinates of the closest edge feature. Depending on the implementation, the gaze point estimator 305 may favor edge features that are also corners when determining the estimated gaze point 177.

The gaze point estimator 305 may further generate a confidence value 306 for each estimated gaze point 167. The confidence value 306 may reflect the confidence that the gaze point estimator 305 has that the estimated gaze point 167 is the true gaze point 167 of the user.

The confidence value 306 associated with the estimated gaze point 167 may be based on the heuristic used to generate the estimated gaze point 167. For example, estimated gaze points 167 generated by the gaze point estimator 305 using the targeting heuristic may have a higher confidence value 306 than gaze points 167 generated using the salient feature heuristic, the text heuristic, face heuristic, or edge heuristic because the targeting heuristic considers input received from the user (e.g., selections), whereas the other heuristics are based only on the coordinates of the gaze point 177 received from the eye tracking component 175.

The confidence value 306 may further be based on the size of the feature 304 that was used to generate the estimated gaze point 167. More specifically, the smaller the feature 304, the larger the generated confidence value 306. For example, with respect to the targeting heuristic, if the user targeted a small feature 304 (e.g., a button, switch, or doorknob) there are less possible coordinates for the estimated gaze point 167 than if the user had targeted a large feature 304. Similarly, for salient features, text features, and face features, the smaller the feature 304 the more likely the coordinates of the center of the feature 304 is the true gaze point of the user, and therefore the greater the generated confidence value 306.

The confidence value 306 may further be based on a distance between the estimated gaze point 167 and the received gaze point 177. More specifically, the smaller the distance, the higher the confidence value 306. For example, with respect to the edge heuristic, if the received gaze point 177 is close to the edge feature that includes the estimated gaze point 167, then the generated confidence value 306 may be greater than if the received gaze point 177 is far from the edge feature that includes the estimated gaze point 167.

The confidence value 306 may further be based on other information provided by the HMD device 100. For example, for the face heuristic, if the user of the HMD device 100, or another person in the field of view of the HMD device 100, was speaking when the gaze point 177 was received, it may be likely that the user of the HMD device 100 was participating in a conversation and therefore more likely that user was looking at a face. Therefore, the confidence value 306 associated with an estimated gaze point 167 that was generated using the face heuristic may be increased by the gaze point estimator 305 when an indication that voices were detected is received from the HMD device 100. Depending on the implementation, the information may be provided by a microphone or other sensor 130 of the HMD device 100.

In another example, the information provided by the HMD device 100 may indicate whether there has been a recent change in the field of view of the HMD device 100. For example, as described above, for the edge heuristic, users are likely to look at edges and corners when they enter a new room, turn around, or perform other tasks that result in a visible change to their environment to orient themselves. Accordingly, when calculating the confidence value 306 for an estimated gaze point 167 that was generated using the edge heuristic, the confidence value 306 may be increased if the information indicates that there was a visible change to the environment. Depending on the implementation, the information may be provided by an accelerometer, GPS, or other sensor 130 of the HMD device 100.

Other factors may be considered when generating the confidence value 306. For example, for estimated gaze points 167 generated using the salient feature heuristics, factors such as the overall density or number of other features 304 that were detected may be considered. For estimated gaze points 167 generated using the text heuristic, factors such as font size and line spacing may be considered.

For estimated gaze points 167 generated using the face heuristics, factors such as whether or not a previously estimated gaze point 167 is near or around an eye of a detected face feature 304 may be considered when generating the confidence value 306. For example, users tend to alternate their gaze between the eyes of a person when making eye contact. Accordingly, when an estimated gaze point 167 is determined to be near an eye of a person using the face heuristic, if a previously determined estimated gaze point 167 is determined to be near the other eye of the person, the confidence value 306 for the estimated gaze point 167 may be increased.

The model engine 310 may receive the estimated gaze points 167 and associated gaze points 177, and may generate and train an adjustment model 311 for the user. The model engine 310 may continue the adjustment model generation phase described above for the gaze point estimator 305. The model engine 310 may continuously update and train the adjustment model 311 as more estimated gaze points 167 are generated based on the received gaze points 177 from the eye tracking component 175 for the user. Any method for generating a model using machine learning may be used.

In some implementations, the model engine 310 may train the adjustment model 311 by determining a difference between the coordinates of the received gaze point 177 and the coordinates of the estimated gaze point 167. The determined difference (if any) may be used to train the model engine 310 for the coordinates associated with the received gaze point 177.

The model engine 310 may consider the confidence values 306 associated with an estimated gaze point 167 when generating or training the adjustment model 311. In some implementations, the estimated gaze points 167 may be weighted proportionally to their associated confidence values 306 so that estimated gaze points 167 with high confidence values 306 “count more” than estimated gaze points 167 with low confidence values 306 for purposes of training the adjustment model 311. Alternatively or additionally, the model engine 310 may only consider estimated gaze points 167 having confidence values 306 that are greater than a threshold confidence value.

Depending on the implementation, the adjustment model 311 may be adapted to receive as an input a gaze point 177 from the eye tracking component 175 for a user, and in response may generate an offset adjustment 168. The generated offset adjustment 168 may be based on the coordinates associated with the receive gaze point 177, and may be a vector or a set of coordinates that may be added to the received gaze point 177 to generate an adjusted gaze point 169. The generated offset adjustment 168 may be based on the differences received for the coordinates (or similar coordinates) that were used by the model engine 310 to train the adjustment model 311.

The offset adjuster 315 may use the adjustment model 311 to generate offset adjustments 168 and/or adjusted gaze points 169. The offset adjuster 315 may operate during what is referred to as the adjustment phase. The adjustment engine 165 may enter the adjustment phase when the user of the HMD device 100 begins to use an application 113 that takes as an input gaze points 177 provided by the eye tracking component 175. These applications 113 may include VR and AR applications. Other types of applications 113 may be supported.

During the adjustment phase, when a gaze point 177 is received for a user, the received gaze point 177 is provided to the offset adjuster 315. The offset adjuster 315 may use the adjustment model 311 and the coordinates of the received gaze point 177 to generate an offset adjustment 168 for the received gaze point 177. The offset adjuster 315 may add the offset adjustment 168 to the received gaze point 177 to generate the adjusted gaze point 169.

The offset adjuster 315 may provide the adjusted gaze point 169 (or the offset adjustment 168) to the application 113 executing on the HMD device 100. The application 113 may use the adjusted gaze point 169 as input instead of the gaze point 177 provided by the eye tracking component 175. As the user continues to use the application 113, the offset adjuster 315 may continue to generate adjusted gaze points 169 from the gaze points 177 received from the eye tracking component 175.

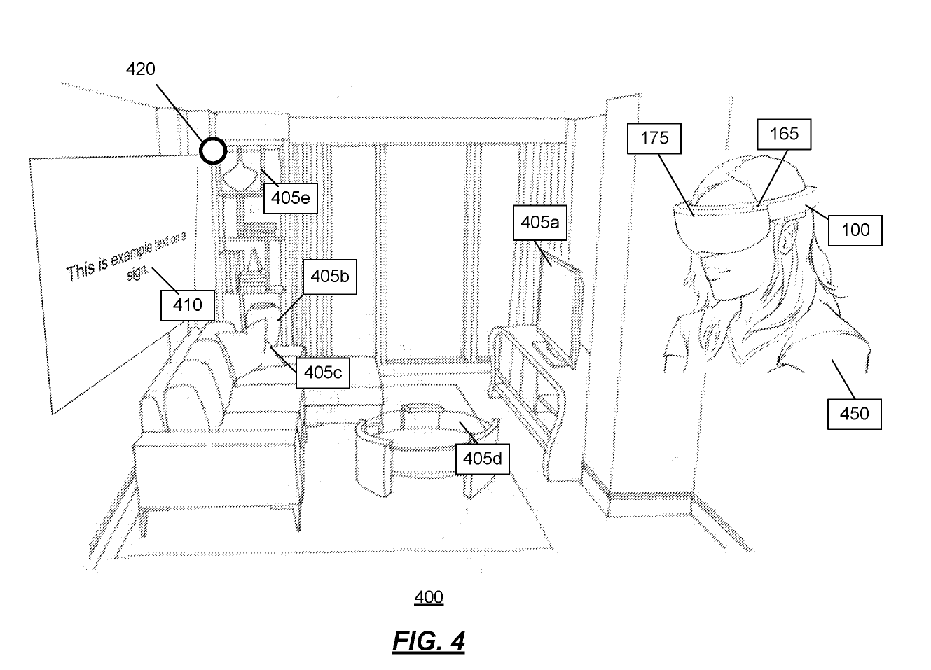

FIG. 4 is an illustration of an example environment 400 showing how estimated gaze points 167 may be generated based on received gaze points 177. As shown, a user 450 is wearing the HMD device 100. The HMD device 100 includes an eye tracking component 175 and an adjustment engine 165. The user 450 may be participating in their normal workflow and may not using any AR applications or VR applications 113.

As the user 450 looks into the room depicted in the environment 400, the feature detector 303 of the adjustment engine 165 may receive field of view data 301 from one or more cameras associated with the HMD device 100. The field of view data 301 may represent the portion of the environment 400 that is visible to the user 450.

In the example shown in FIG. 4, the feature detector 303 has detected several features 304 in the environment 400. These features 304 include an object feature 405a that corresponds to a television, an object feature 405b that corresponds to a vase, an object feature 405c that corresponds to a pillow, an object feature 405d that corresponds to a coffee table, and an object feature 405e that corresponds to a vase. The features 304 also include text features 410 corresponding to the phrase “This is example text on a sign.” Depending on the implementation, each word or letter of the phase may be a separate text feature. Note that many more features 304 appear in FIG. 4 (including edge and corner features). However, these features are not explicitly identified for purposes of brevity.

As the user looks around the environment 400, the eye tracking apparatus 175 generates a gaze point 177 that is provided to the adjustment engine 165. The generated gaze point 177 is shown the environment 400 as the area 420.

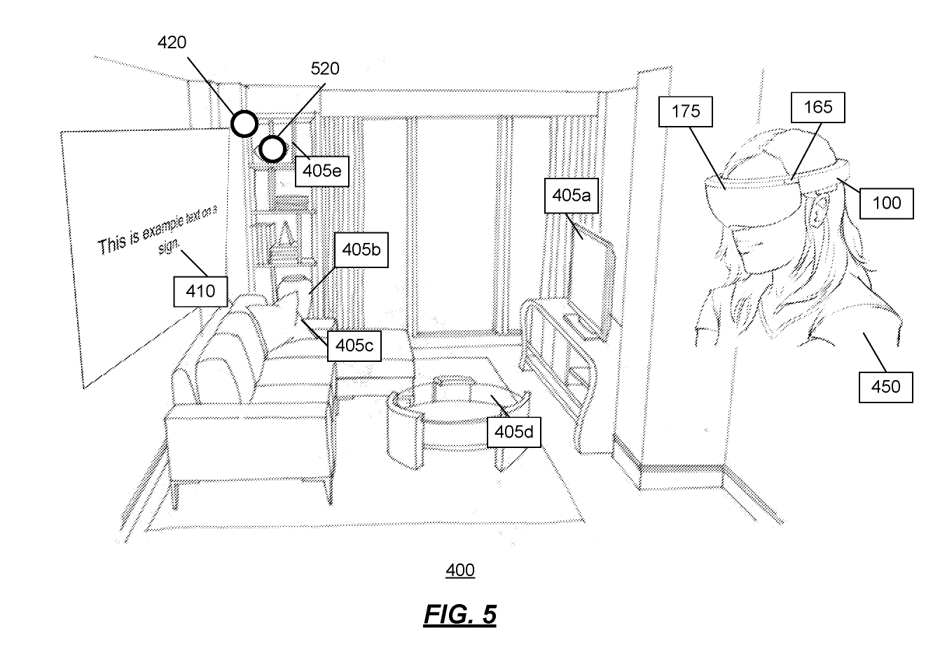

Continuing to FIG. 5, the adjustment engine 165 receives the generated gaze point 177 represented by the area 420 and determines that the area 420 is near the object feature 405e. Accordingly, the gaze point estimator 305 of the adjustment engine 165 uses the coordinates of the area 420 and the salient feature heuristic to generate an estimated gaze point 167. The coordinates of the estimated gaze point 167 are based on the coordinates of the object feature 405e, and are shown in the environment 400 as the area 520. The estimated gaze point 167 and the received gaze point 177 may be used to train the adjustment model 311 for the user 450.

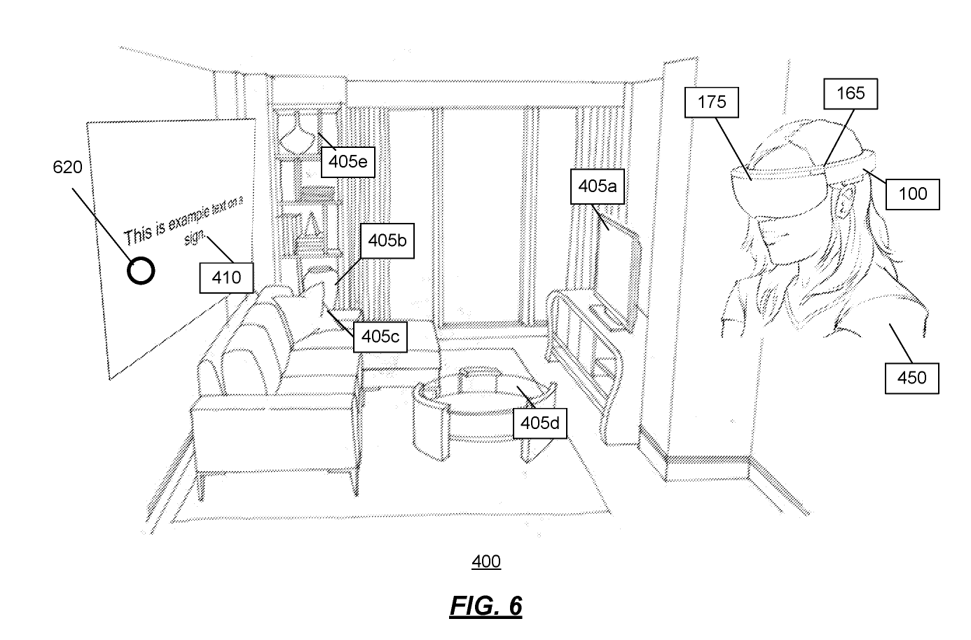

Continuing to FIG. 6, as the user continues to look around the environment 400, the eye tracking apparatus 175 generates a new gaze point 177 that is provided to the adjustment engine 165. The new generated gaze point 177 is shown the environment 400 as the area 620.

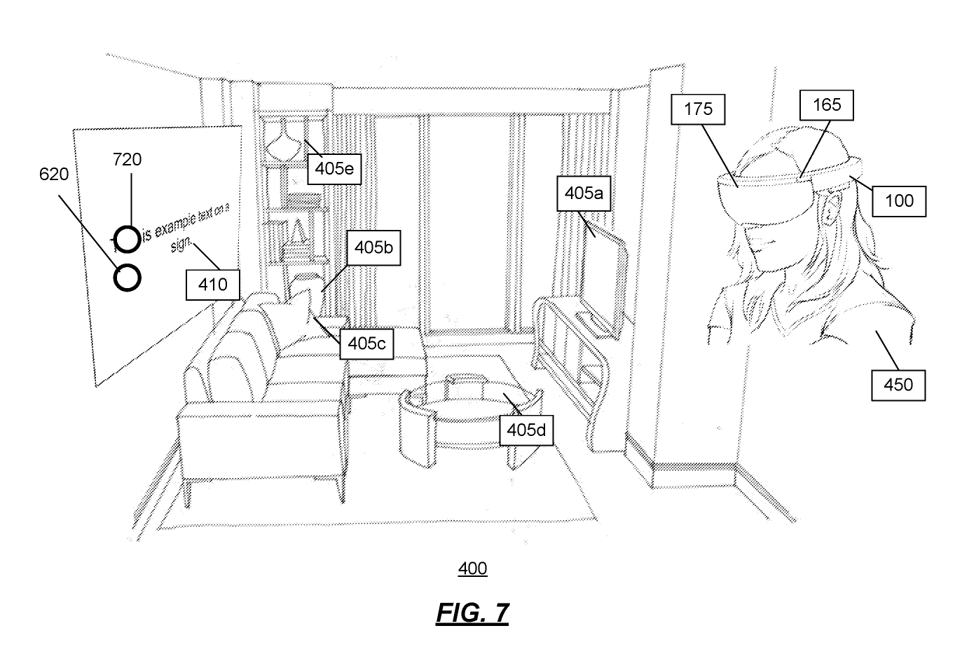

Continuing to FIG. 7, the adjustment engine 165 receives the generated gaze point 177 represented by the area 620 and determines that the area 620 is near some of the text features 410. Specifically, the adjustment engine 165 determines that the area 620 is near the text feature 410 “This.” Accordingly, the gaze point estimator 305 of the adjustment engine 165 uses the coordinates of the area 620 and the text feature heuristic to generate an estimated gaze point 167. The coordinates of the estimated gaze point 167 are shown in the environment 400 as the area 720. The estimated gaze point 167 and the received gaze point 177 may be used to train the adjustment model 311 for the user 450.

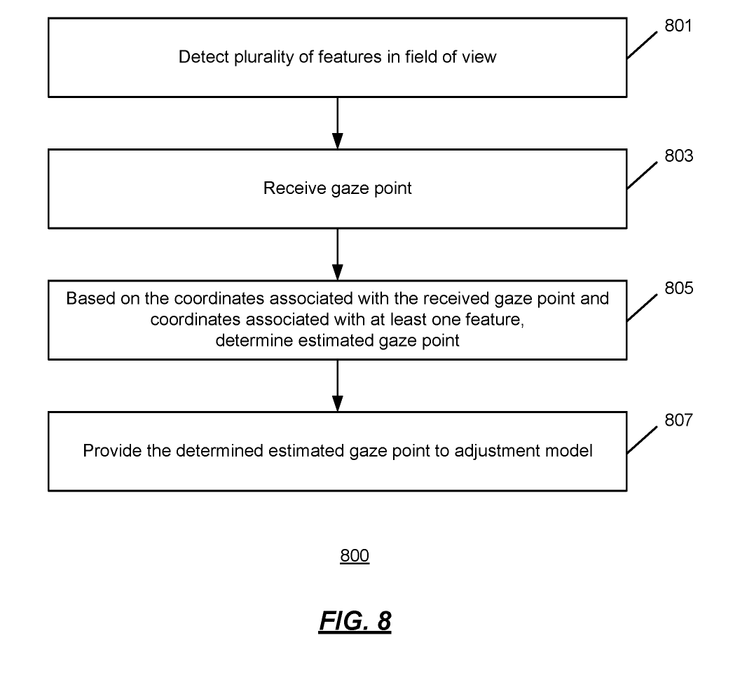

FIG. 8 is an operational flow of an implementation of a method 800 for determining an estimated gaze point based on a gaze point received from an eye tracking component 175. The method 800 may be implemented by one or both of a HMD device 100 and an adjustment engine 165.

At 801, a plurality of features in a field of view is detected. The plurality of features 304 may be detected by the feature detector 303 of the adjustment engine 165. The features 304 may be visible to a wearer or a user of the HMD device 100. The features 304 may be determined from field of view data 301. Each feature 304 may have coordinates with respect to a near eye display system 110 of the HMD device 100.

At 803, a gaze point is received. The gaze point 177 may be received by the adjustment engine 165. The gaze point 177 may be associated with coordinates on the near eye display system 110 of the HMD device 100. The gaze point 177 may be received from an eye tracking component 175 associated with the HMD device 100. The gaze point 177 may represent a point or area that the wearer of the HMD device 100 is currently looking at, but because of an error in calibration of the eye tracking component 175, the gaze point 177 may not accurately reflect a true gaze point of the wearer.

At 805, based on the coordinates associated with the received gaze point and coordinates associated with at least one feature, an estimated gaze point is determined. The estimated gaze point 167 may be determined by the gaze point estimator 305. Depending on the implementation, the estimated gaze point 167 may be estimated using one or more heuristics that estimate the “true” gaze point of the user using the coordinates associated with the gaze point 177 and the coordinates of a feature 304 that is closest to the gaze point 177. The heuristics may include a targeting heuristic, a salient feature heuristic, a text heuristic, a face heuristic, and an edge or corner heuristic. Other heuristics may be used.

At 807, the determined estimated gaze point is provided to an adjustment model. The determined estimated gaze point 167 may be provided to the adjustment model 311 by the model engine 310. The model engine 310 may use the determined estimated gaze point 167 and the received gaze point 177 to train the adjustment model 311.

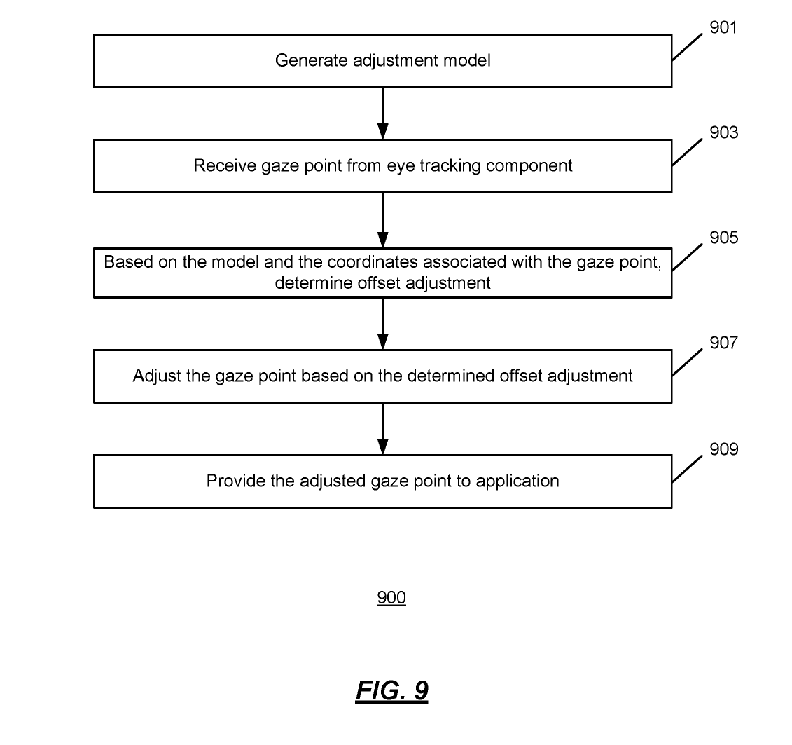

FIG. 9 is an operational flow of an implementation of a method 900 for generating an adjustment model and for adjusting a received gaze point using the generated adjustment model. The method 900 may be implemented by one or both of a HMD device 100 and an adjustment engine 165.

At 901, an adjustment model is generated. The adjustment model 311 may be generated by the model engine 310 of the adjustment engine 165. The adjustment model 311 may be generated by the model engine 310 by comparing gaze points 177 received from an eye tracking component 175 with estimated gaze points 167 determined from coordinates of the received gaze points 177 and coordinates associated with features 304 visible in a field of view of the HMD device 100. The adjustment model 311 may be used to correct or adjust gaze points 177 generated by the eye tracking component 175 without having to perform a user specific recalibration of the eye tracking component 175.

At 903, a gaze point is received. The gaze point 177 may be received by the offset adjuster 315. The gaze point 177 may be associated with coordinates of a near eye display system 110 of the HMD device 100. The gaze point 177 may be received from the eye tracking component 175 associated with the HMD device 100. The user may be executing an application 113 that uses the received gaze point 177 as input. The application 113 may be a VR application or an AR application 113.

At 905, based on coordinates associated with the received gaze point and the adjustment model, an offset adjustment is determined. The offset adjustment 168 may be determined by the offset adjuster 315. The offset adjustment 168 may be a vector or a set of values that may be added to the gaze point 177 to create an adjusted gaze point 169 that corrects for the miscalibration of the eye tracking component 175.

At 907, the gaze point is adjusted based on the determined offset adjustment. The gaze point 177 may be adjusted by the offset adjuster 315 adding the offset adjustment 168 to the gaze point 177 to create the adjusted gaze point 169.

At 909, the adjusted gaze point is provided to the application. The adjusted gaze point 169 may be provided to the application 113 of the HMD device 100 that uses gaze points 177 as an input. The adjusted gaze point 169 may be provided to the application 113 in place of the gaze point 177.

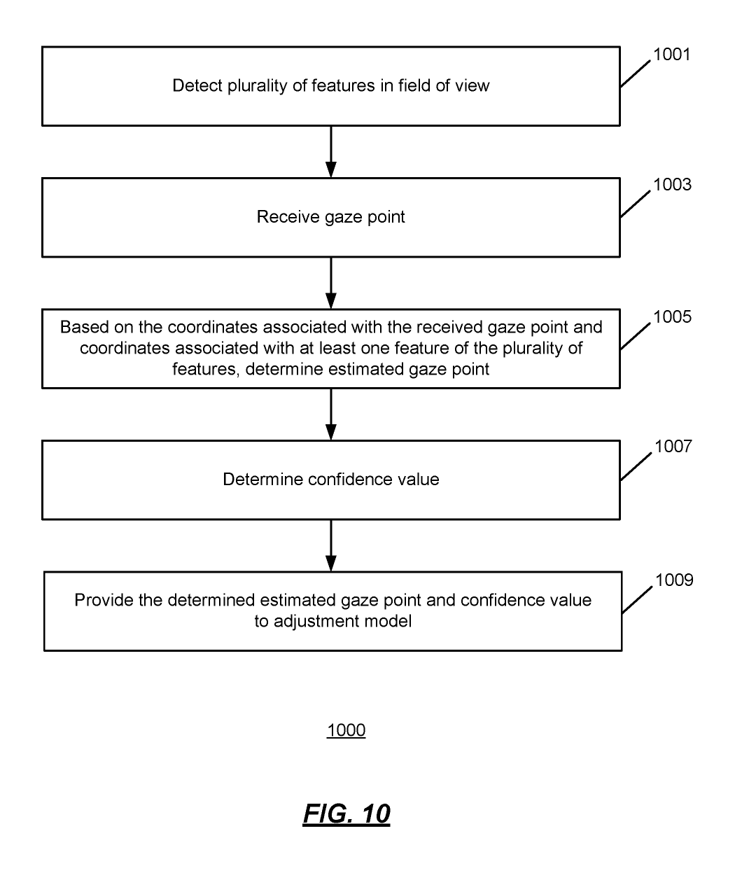

FIG. 10 is an operational flow of an implementation of a method 1000 for determining an estimated gaze point and a confidence value based on a gaze point received from an eye tracking component. The method 1000 may be implemented by one or both of a HMD device 100 and an adjustment engine 165.

At 1001, a plurality of features in a field of view is detected. The plurality of features 304 may be detected by the feature detector 303 of the adjustment engine 165. The features 304 may be visible to a wearer of the HMD device 100. The features 304 may be determined from field of view data 301. Each feature 304 may have coordinates with respect to a near eye display system 110 of the HMD device 100.

At 1003, a gaze point is received. The gaze point 177 may be received by the adjustment engine 165. The gaze point 177 may be associated with coordinates on the near eye display system 110 of the HMD device 100. The gaze point 177 may be received from an eye tracking component 175 associated with the HMD device 100.

At 1005, based on the coordinates associated with the received gaze point and coordinates associated with at least one feature of the plurality of features, an estimated gaze point is determined. The estimated gaze point 167 may be determined by the gaze point estimator 305. Depending on the implementation, the estimated gaze point 167 may be estimated using one or more heuristics.

At 1007, a confidence value is determined. The confidence value 306 may be determined for the estimated gaze point 167 by the gaze point estimator 305. Depending on the implementation, the gaze point estimator 305 may determine the confidence value 306 based on the heuristics that were used to determine the estimated gaze point 167 and/or a size of the at least one feature 304 of the plurality of features 304. Other information such as the number of features 304 in the plurality of features 304 may be used.

At 1009, the determined estimated gaze point and the confidence value are provided to an adjustment model. The determined estimated gaze point 167 and the confidence value 306 may be provided to the adjustment model 311 by the model engine 310. The model engine 310 may use the determined estimated gaze point 167, the confidence value 306, and the received gaze point 177 to train the adjustment model 311.

FIG. 11 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 11, an exemplary system for implementing aspects described herein includes a computing device, such as computing device 1100. In its most basic configuration, computing device 1100 typically includes at least one processing unit 1102 and memory 1104. Depending on the exact configuration and type of computing device, memory 1104 may be volatile (such as random access memory (RAM)), non-volatile (such as read-only memory (ROM), flash memory, etc.), or some combination of the two. This most basic configuration is illustrated in FIG. 11 by dashed line 1106.

Computing device 1100 may have additional features/functionality. For example, computing device 1100 may include additional storage (removable and/or non-removable) including, but not limited to, magnetic or optical disks or tape. Such additional storage is illustrated in FIG. 11 by removable storage 1108 and non-removable storage 1110.

Computing device 1100 typically includes a variety of computer readable media. Computer readable media can be any available media that can be accessed by the device 1100 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1104, removable storage 1108, and non-removable storage 1110 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1200. Any such computer storage media may be part of computing device 1100.

Computing device 1100 may contain communication connection(s) 1112 that allow the device to communicate with other devices. Computing device 1100 may also have input device(s) 1114 such as a keyboard, mouse, pen, voice input device, touch input device, etc. Output device(s) 1116 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

In an implementation, a system for determining estimated gaze points based on received gaze points to avoid recalibration of an eye tracking component is provided. The system includes a head mounted display device and an adjustment engine. The adjustment engine: detects a plurality of features in a field of view of the head mounted display device, wherein each feature is associated with coordinates on the head mounted display device; receives a first gaze point, wherein the first gaze point is associated with coordinates on the head mounted display device; based on the coordinates associated with the first gaze point and the coordinates associated with at least one feature of the plurality of features, determines an estimated gaze point; and provides the determined estimated gaze point to an adjustment model.

Implementations may include some or all of the following features. The adjustment engine further: determines a feature of the plurality of features that is closest to the first gaze point based on the coordinates associated with the first gaze point and the coordinates associated with the feature of the plurality of features; and based on the coordinates associated with the first gaze point and the coordinates associated with the determined closest feature of the plurality of features, determines the estimated gaze point. The adjustment engine further: based on a size of the closest feature of the plurality of features, determines a confidence value for the determined estimated gaze point; and provides the determined confidence value and the estimated gaze point to the adjustment model. The adjustment engine further: detects a targeting of a feature of the plurality of features by a hand of a wearer of the head mounted display device; and based on the coordinates associated with the gaze point, the coordinates associated with the targeted feature of the plurality of features, determines the estimated gaze point. The adjustment engine further: based on a size of the targeted feature of the plurality of features, determines a confidence value for the determined estimated gaze point; and provides the determined confidence value and the estimated gaze point to the adjustment model. The at least one feature is a text feature, and the adjustment engine further: based on a size and line spacing associated with the text feature, determines a confidence value for the determined estimated gaze point; and provides the determined confidence value and the estimated gaze point to the adjustment model. The adjustment model is associated with a wearer of the head mounted display device. The first gaze point is received from an eye tracking component of the head mounted display device. The adjustment engine further: receives a second gaze point, wherein the second gaze point is associated with coordinates on the head mounted display device; determines an offset adjustment for the second gaze point using the adjustment model and the coordinates associated with the second gaze point; adjusts the second gaze point based on the determined offset adjustment; and provides the adjusted second gaze point to an application. The application is an augmented reality application.

In an implementation, a system for adjusting gaze points without recalibrating an eye tracking component is provided. The system includes a head mounted display device, an eye tracking component, and an adjustment engine. The adjustment engine: generates an adjustment model for a wearer of the head mounted display device; receives a first gaze point for the user from the eye tracking component, wherein the first gaze point is associated with coordinates on the head mounted display device; based on the adjustment model and the coordinates associated with the first gaze point, determines an offset adjustment for the first gaze point; adjusts the first gaze point based on the determined offset adjustment; and provides the adjusted first gaze point to an application.

Implementation may include some or all of the following features. The adjustment engine: detects a plurality of features in a field of view of the head mounted display device, wherein each feature is associated with coordinates on the head mounted display device; receives a second gaze point for the wearer, wherein the second gaze point is associated with coordinates on the head mounted display device; based on the coordinates associated with the second gaze point and the coordinates associated with at least one feature of the plurality of features, determines an estimated gaze point; determines a confidence value for the determined estimated gaze point; and generates the adjustment model based on the determined estimated gaze point and the determined confidence value. The at least one feature is a text feature and the adjustment engine further determines the confidence value for the determined estimated gaze point based on a size and line spacing associated with the text feature. The adjustment engine further: determines a feature of the plurality of features that is closest to the second gaze point based on the coordinates associated with the second gaze point and the coordinates associated with the feature of the plurality of features; and based on the coordinates associated with the second gaze point and the coordinates associated with the determined closest feature of the plurality of features, determines the estimated gaze point. The adjustment engine determines the confidence value for the determined estimated gaze point based on a size of the determined closest feature. The adjustment engine further: detects a targeting of a feature of the plurality of features by a hand of a wearer of the head mounted display device; and based on the coordinates associated with the gaze point, the coordinates associated with the targeted feature of the plurality of features, determines the estimated gaze point. The adjustment engine determines the confidence value for the determined estimated gaze point based on a size of the targeted feature.

In an implementation, a method for determining estimated gaze points based on received gaze points to reduce recalibration of an eye tracking component is provided. The method includes: detecting a plurality of features in a field of view of a head mounted display device, wherein each feature is associated with coordinates on the head mounted display device; receiving a gaze point by the head mounted display device, wherein the gaze point is associated with coordinates on the head mounted display device; based on the coordinates associated with the received gaze point and the coordinates associated with at least one feature of the plurality of features, determining an estimated gaze point by the head mounted display device; calculating a confidence value for the determined estimated gaze point by the head mounted display device; and providing the determined estimated gaze point and determined confidence value to an adjustment model by the head mounted display device.

Implementations may include some or all of the following features. The method may further include: determining a feature of the plurality of features that is closest to the received gaze point by the head mounted display device based on the coordinates associated with the received gaze point and the coordinates associated with the feature of the plurality of features; and based on the coordinates associated with the received gaze point and the coordinates associated with the determined closest feature of the plurality of features, determining the estimated gaze point by the head mounted display device. The method may further include: detecting a targeting of a feature of the plurality of features by a hand of a wearer of the head mounted display device; and based on the coordinates associated with the gaze point, the coordinates associated with the targeted feature of the plurality of features, determining the estimated gaze point by the head mounted display device.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A system for determining estimated gaze points based on received gaze points to avoid recalibration of an eye tracking component, the system comprising:
a head mounted display device; and
an adjustment engine that:
detects a plurality of features in a field of view of the head mounted display device, wherein each feature is associated with coordinates on the head mounted display device;
receives a first gaze point, wherein the first gaze point is associated with coordinates on the head mounted display device;
based on the coordinates associated with the first gaze point and the coordinates associated with at least one feature of the plurality of features, determines an estimated gaze point;
based on a visually-identifiable property of the at least one feature of the plurality of features, determines a confidence value for the determined estimated gaze point; and
provides the determined confidence value and the determined estimated gaze point to an adjustment model.

2. The system of claim 1, wherein the adjustment engine further:
determines a feature of the plurality of features that is closest to the first gaze point based on the coordinates associated with the first gaze point and the coordinates associated with the feature of the plurality of features; and
based on the coordinates associated with the first gaze point and the coordinates associated with the determined closest feature of the plurality of features, determines the estimated gaze point.

3. The system of claim 2, wherein the adjustment engine further:
based on a size of the closest feature of the plurality of features, determines a confidence value for the determined estimated gaze point; and
provides the determined confidence value and the estimated gaze point to the adjustment model.

4. The system of claim 1, wherein the adjustment engine further:
detects a targeting of a feature of the plurality of features by a hand of a wearer of the head mounted display device; and
based on the coordinates associated with the gaze point, and the coordinates associated with the targeted feature of the plurality of features, determines the estimated gaze point.

5. The system of claim 4, wherein the adjustment engine further:
based on a size of the targeted feature of the plurality of features, determines a confidence value for the determined estimated gaze point; and
provides the determined confidence value and the estimated gaze point to the adjustment model.

6. The system of claim 1, wherein the at least one feature is a text feature, and the adjustment engine further:
based on a size and line spacing associated with the text feature, determines a confidence value for the determined estimated gaze point; and
provides the determined confidence value and the estimated gaze point to the adjustment model.

7. The system of claim 1, wherein the adjustment model is associated with a wearer of the head mounted display device.

8. The system of claim 1, wherein the first gaze point is received from an eye tracking component of the head mounted display device.

9. The system of claim 1, wherein the adjustment engine further:
receives a second gaze point, wherein the second gaze point is associated with coordinates on the head mounted display device;
determines an offset adjustment for the second gaze point using the adjustment model and the coordinates associated with the second gaze point;
adjusts the second gaze point based on the determined offset adjustment; and
provides the adjusted second gaze point to an augmented reality application.

10. (canceled)

11. A system for adjusting gaze points without recalibrating an eye tracking component, the system comprising:
a head mounted display device;
an eye tracking component; and
an adjustment engine that:
generates an adjustment model for a wearer of the head mounted display device;
receives a first gaze point for the wearer from the eye tracking component, wherein the first gaze point is associated with coordinates on the head mounted display device;
based on the adjustment model and the coordinates associated with the first gaze point, determines an offset adjustment for the first gaze point;
adjusts the first gaze point based on the determined offset adjustment;
based on a visually-identifiable property of the at least one feature of the plurality of features, determines a confidence value for the adjusted first gaze point; and
provides the confidence value and the adjusted first gaze point to an application.

12. The system of claim 11, wherein the adjustment engine further:
detects a plurality of features in a field of view of the head mounted display device, wherein each feature is associated with coordinates on the head mounted display device;
receives a second gaze point for the wearer, wherein the second gaze point is associated with coordinates on the head mounted display device;
based on the coordinates associated with the second gaze point and the coordinates associated with at least one feature of the plurality of features, determines an estimated gaze point;
determines a confidence value for the determined estimated gaze point; and
generates the adjustment model based on the determined estimated gaze point and the determined confidence value.

13. The system of claim 12, wherein the at least one feature is a text feature and the adjustment engine further determines the confidence value for the determined estimated gaze point based on a size and line spacing associated with the text feature.

14. The system of claim 11, wherein the adjustment engine further:
determines a feature of the plurality of features that is closest to the second gaze point based on the coordinates associated with the second gaze point and the coordinates associated with the feature of the plurality of features; and
based on the coordinates associated with the second gaze point and the coordinates associated with the determined closest feature of the plurality of features, determines the estimated gaze point.

15. The system of claim 14, wherein the adjustment engine determines the confidence value for the determined estimated gaze point based on a size of the determined closest feature.

16. The system of claim 11, wherein the adjustment engine further:
detects a targeting of a feature of the plurality of features by a hand of a wearer of the head mounted display device; and
based on the coordinates associated with the gaze point, and the coordinates associated with the targeted feature of the plurality of features, determines the estimated gaze point.

17. The system of claim 15, wherein the adjustment engine determines the confidence value for the determined estimated gaze point based on a size of the targeted feature.

18. A method for determining estimated gaze points based on received gaze points to reduce recalibration of an eye tracking component, the method comprising:
detecting a plurality of features in a field of view of a head mounted display device, wherein each feature is associated with coordinates on the head mounted display device;
receiving a gaze point by the head mounted display device, wherein the gaze point is associated with coordinates on the head mounted display device;
based on the coordinates associated with the received gaze point and the coordinates associated with at least one feature of the plurality of features, determining an estimated gaze point by the head mounted display device;
based on a visually-identifiable property of the at least one feature of the plurality of features, calculating a confidence value for the determined estimated gaze point by the head mounted display device; and
providing the confidence value and the determined estimated gaze point and determined confidence value to an adjustment model by the head mounted display device.

19. The method of claim 18, further comprising:
determining a feature of the plurality of features that is closest to the received gaze point by the head mounted display device based on the coordinates associated with the received gaze point and the coordinates associated with the feature of the plurality of features; and
based on the coordinates associated with the received gaze point and the coordinates associated with the determined closest feature of the plurality of features, determining the estimated gaze point by the head mounted display device.

20. The method of claim 18, further comprising:
detecting a targeting of a feature of the plurality of features by a hand of a wearer of the head mounted display device; and
based on the coordinates associated with the gaze point, the coordinates associated with the targeted feature of the plurality of features, determining the estimated gaze point by the head mounted display device.

21. The system of claim 1, wherein the determined confidence value for the determined estimated gaze point represents a weighting of the determined estimated gaze point within the adjustment model.
